(19) United States
(12) Patent Application Publication
(10) Pub. No.: US 2006/0288123 A1
(43) Pub. Date: Dec. 21, 2006

(54) Interface for transcoding system

(75) Inventor: Eran Vered, Ramat Gan (IL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/569,720

(22) PCT Filed: Aug. 20, 2004
(86) PCT No.: PCT/IB04/02763

§ 371 Date: Feb. 24, 2006

(30) Foreign Application Priority Data
Sep. 1, 2003 (EP) 033001066

(51) Int. Cl. G06F 15/16

(52) U.S. Cl. 709/246

(57) ABSTRACT

The invention relates to a transcoding system comprising an application platform and a transcoding platform for executing transcoding transactions that comprise the transmission of a request from the application platform to the transcoding platform, the execution of said request by said transcoding platform, and the transmission of a response to said application platform, said request and response having specific formats given in detailed tables. Moreover, the request has a transcoding parameter element comprising a transformation element that defines a transformation through which a content must go, amongst a plurality of supported transformations also defined in a detailed table.

### FIELD OF THE INVENTION

The present invention relates to a transcoding system comprising an application platform and a transcoding platform for executing transcoding transactions that comprise the following steps:
transmission of a request from said application platform to said transcoding platform,
execution of said request by said transcoding platform,
transmission of a response from said transcoding platform to said application platform.

In the present description, the word “platform” refers to a combination of hardware and software that provides the functionality of the concerned applications.

### BACKGROUND OF THE INVENTION

The deployment of multimedia applications like MMS Multimedia Messaging Service), WAP 2 (Wireless Application Protocol), e-mail, web browsing . . . etc.) may require some Content adaptations, due to the diversity of the phone specifications (memory, screen size, resolution, colour depth, etc, and supported media formats) and of the media formats as distributed by the Content industry (JPEG, GIF, all AMR modes, 13K vocoder, EVRC, SMV, MPEG-1, MPEG-4, H.263 . . . etc.). The word “Content” used here means any subject matter or information that is processed, stored or transmitted electronically. Content Adaptation is largely independent on the type of service that delivers the data to the end users. In this context, STI 1.0 is the first specification of a standard interface between the Multimedia Application Platforms and the Transcoding Platform and is meant to resolve some of the integration and testing problems when deploying multimedia services towards mobile devices.

### SUMMARY OF THE INVENTION

The object of the invention is to propose a new solution for the standard interface, to be used by OMA STI 1.0. (OMA=Open Mobile Alliance).

To this end, the invention relates to a transcoding system such as defined in the introductory paragraph of the description and in which said request is based on a request body which is structured as indicated in Table 1, and said response, when successful, is based on a response body which is structured as indicated in Table 3.

### BRIEF DESCRIPTION OF THE DRAWINGS

The present invention will now be described, by way of example, with reference to the accompanying drawings in which:

FIG. 1 illustrates a transcoding transaction;

FIG. 2 shows an overview of the request components for such a transaction;

FIG. 3 presents the transcoding job structure, including the source parameters and the target parameters,

FIG. 4 presents the response transaction structure, and

FIG. 5 presents the job result structure;

FIG. 6 is an example of combined media format;

FIG. 7 shows the structure of a request transaction, and

FIG. 8 the structure of a response transaction.

### DETAILED DESCRIPTION OF THE INVENTION

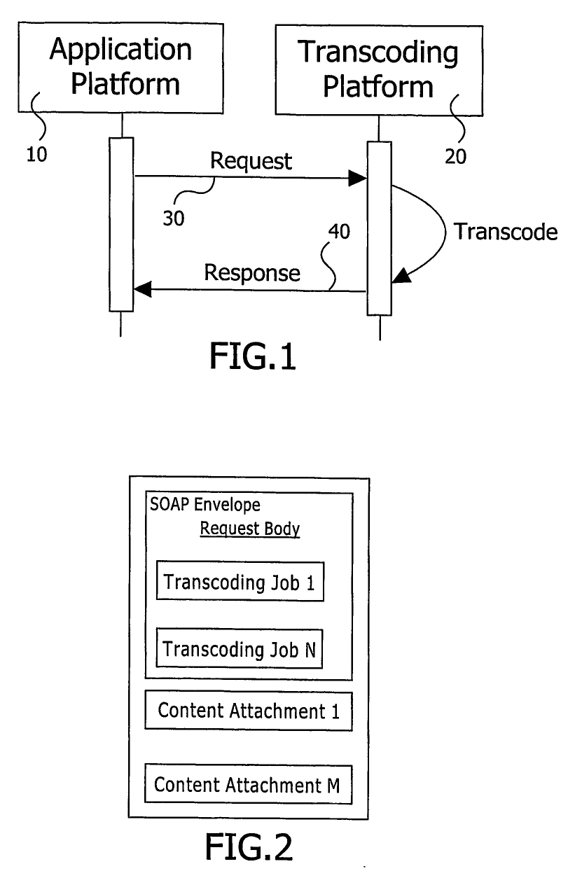

A high level overview of the interaction between an Application Platform 10 and a Transcoding Platform 20 is illustrated in FIG. 1. The communication between the Platforms is transactional, that is a transcoding session is always a request 30 followed by a response 40. A session is closed only when a response has been received. The Application Platform requests transcoding from the Transcoding Platform. The Transcoding Platform receives the request, parses it, handles it and generates a response to the originating Application Platform.

The choice of the protocol is done as follows. The interface between Application Platform and the Transcoding Platform relies on a SOAP protocol (SOAP v 1.1, http://www.w3.org/TR/SOAP/), sent over HTTP (HyperText Transfer Protocol) and used over TCP/IP (Transmission Control Protocol/Internet Protocol).

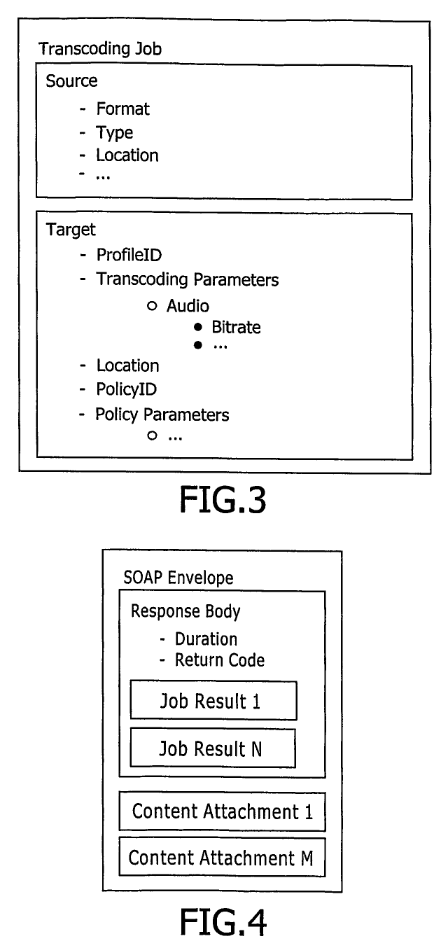

FIG. 2 shows an overview of the request components. Multiple bulk transcoding within a single Request Transaction (=transcoding request, as issued by the Application Platform; it can contain one or more Transcoding Jobs 1 to N and one or more Content Attachments 1 to M, a Transcoding Job being the part of the Request Transaction that corresponds to one individual transcoding, i.e. one input content reference and the parameters corresponding to the particular transcoding as given by the Application Platform) is allowed by the proposed interface: therefore one will distinguish between Transcoding Job (individual media transcoding) and Request Body (list of Job results) which can contain one or several Jobs as part of one single request to the Transcoding Platform. For each single Transcoding Job within a Request body, the transcoding parameters are specified within the SOAP context. In case a Transcoding Job contains the Content files themselves, they are attached inside the concerned message, but outside the SOAP envelope. Each Transcoding Job in a Request Body has to contain the source parameters (format, type, location, etc) and the target parameters (profile ID, transcoding parameters, location, policy ID, policy parameters, etc), as presented in FIG. 3. The proposed Request Transaction structure supports all the Content types within the scope of STI 1.0: images, audio, speech, video, text, presentation formats and combined media . . . etc.

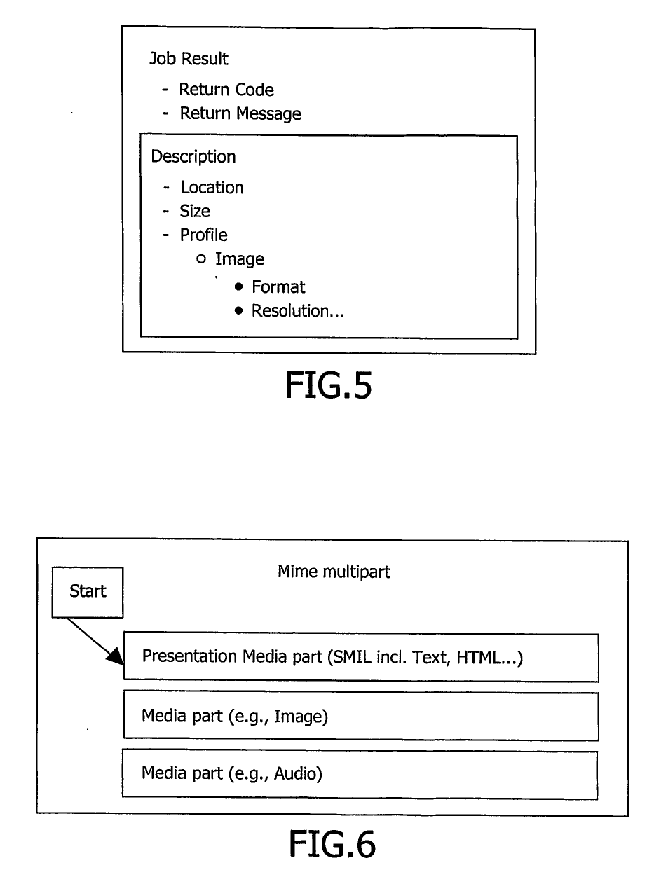

The Response transaction (response of the Transcoding Platform to the Request Transaction) contains the Job Results (the Transcoding Jobs' results 1, 2, . . . , N), as presented in FIG. 4. In this Response Body, parameters (duration, return code, etc) either concern the whole Transaction or the individual Transcoding Jobs' results. For example, the duration corresponds to the complete Transaction duration. Still, in the job Results, there might also be some parameters describing the particular transcoding that was performed (i.e. image 1 was transcoded from GIF—Graphic Interchange Format—to JPEG—Joint Photographic Experts Group). The proposed interface supports reporting of statistical data gathered during the transcoding at the Job and Transaction levels. The Job Results contained in the Transaction are detailed in FIG. 5. The Source block of each Transcoding Job may specify the source type, format and parameters. The Target block of each Transaction Job has to specify the desired transcoding parameters and can specify Policy parameters.

The proposed interface also supports transcoding of combined media Content, i.e a set of media elements can be transcoded as a whole. In this case, it is expected that the Transcoding Platform receives a combined media file, performs combined transcoding of the difference media elements (including any logical decisions between the different media elements) and recombines these elements into one transcoded combined media file as a response. The combined-media is transferred as a MIME-Multipart content item (MIME Part 1 (2, 3, . . . ): see http://www.ietf.org/rfc/rfc2045(to2049).txt). The MIME type is either multipart/related (in case a presentation exists) or multipart/mixed (in case a presentation does not exist). In the first case, the start parameter refers to the presentation part. FIG. 6 illustrates the structure of a combined media (with a presentation part). The encoding of the MIME-Multipart (both input and output) is either textual, as defined in [MIME], or WAP binary encoding, as defined in [WAPWSP] (“Wireless Application Protocol, Wireless Session Protocol Specification”, WAP-203-WSP-20000504-a, WAP Forum™. URL [Uniform Resource Locator]=http://www.openmobilealliance.org). The requested encoding for the target MIME-Multipart is specified in the transcoding parameters of the Transcoding Job. The Content data (either combined media or individual media parts) is referenced from within the SOAP Request Body (and Response Body), and resides either on a storage that can be accessed by the Transcoding Platform or attached as part of the Transaction itself. The proposed interface provides two methods of supporting media attachments:

self contained requests, in which the content data reside within the Transaction itself;

references to external Content elements, in which case the Transaction only contains a pointer to a remote location from where the Content elements can be pulled by the Transcoding Platform.

Each of the methods will be described below (note that the two options can be combined within one Transaction containing references (URLs) to external Content elements and attached Content elements). In the case references to external Content elements are used, the SOAP Request/Response Body contains the URLs, pointing to the relevant files, and the Application Platform and the Transcoding Platform have access to a shared persistent storage device, either “local” or accessible via HTTP or FTP (File Transfer Protocol). In case of self-contained requests, the SOAP Request/Response Body contains references to the attachments sent along with the Transaction, as MIME parts. Each content attachment is identified by its MIME Content ID. The SOAP Request/Response Body refers to the content, using the Content IDs.

The transcoding parameters are the parameters that determine the target the Transcoding platform has to create. To specify the transcoding parameters, the Application Platform uses predefined Profiles and/or explicit transcoding parameters (note that in all cases, the Transcoding Platform can complement the list of parameters, but one of the Transcoding Platform parameters overrides the parameters that the Application Platform indicated in the Request Transaction). The transcoding parameters can be indicated using a reference to a pre-defined Profile (a profile is a set of parameters and constraints that define the transcoding target). One common use of a Profile is to describe the user Equipment (=a device allowing a user access to network services) characteristics. The profile reference can then be a reference to the database that both the Transcoding and Application Platforms share. In order to use a predefined profile, the Request Transaction specifies the Profile ID of the profile to be used (the definition of a profile and its content are out of the scope of the present description). The transcoding parameters can also be indicated using an explicit list of parameters, which will reflect the characteristics of the target device and/or the specific requirements from the Application. When a Profile ID is indicated and explicit parameters are added, the explicit parameters override the corresponding parameters in the referenced Profile.

Policy parameters are a mean for the Application Platform to specify general rules (general limitations and preferences) for the Request Transaction (i.e. priority order between the different media elements, . . . ). To specify the Policy parameters, the Application Platform uses predefined Policy and/or explicit Policy parameters. When a PolicyID is indicated and explicit policy parameters are added, the explicit parameters override the corresponding parameters in the referenced Policy.

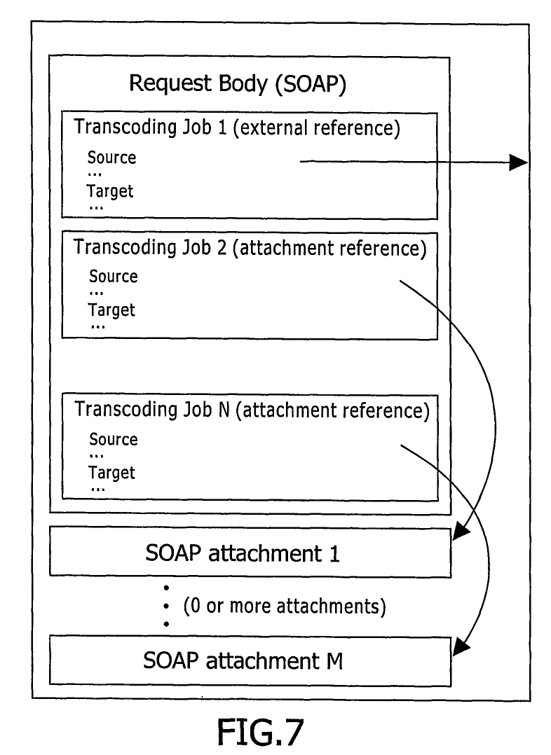

The request transaction will now be explained in detail. As mentioned above, the Request Transactions contain a SOAP header, made of Transcoding Jobs, and can contain one or several Content attachments (if some Content elements are contained in the Transaction itself). All Content elements to be transcoded are referenced in the Transcoding Jobs (pointing to an attachment or an external source). The Request Transaction contains at least one Transcoding Job, and it can contain several Transcoding Jobs. FIG. 7 shows the structure of a Request Transaction. Request Transactions that do no contain attachments (all the files are referenced using a URLs pointing to external sources) have a SOAP header and a SOAP-based Request Body. The SOAP header specifies the originating host, the length, the request encoding and the SOAP action. Request Transactions with Content attachments contain the SOAP header and a string that will indicate the boundary between each content attachment, as defined in MIME (see [MIME]). Each Content attachment contains its own header (using MIME). Each Content Attachment header contains its unique ID, its type, its encoding and its length.

According to the invention, the SOAP-based Request Body is structured as indicated in the following Table 1 (in which the structures are written in bold):

TABLE 1

| | | | | Mandatory/ | |
|---|---|---|---|---|---|
| parent | Name | Type | Possible Values | Optional | Comments |
| | Transaction | | | Mandatory | Several Transcoding Jobs |
| | | | | | can be sent within one |
| | | | | | request. |
| Transaction | TransactionID | Integer | | Mandatory | A unique ID that is given by |
| | | | | | the Application Platform. |
| Transaction | NumTranscodingJobs | Integer | | Optional | How many Transcoding |
| | | | | | Jobs reside in this |
| | | | | | Transaction. |
| Transaction | Priority | Integer | 0-2 | Optional | The priority of the |
| | | | | | Transaction (0 is the |
| | | | | | highest, default is 1) |
| | | | | | compared to others. |
| Transaction | ProfileID | String | | Optional | The pre-defined Profile to be |
| | | | | | used for all the Transcoding |
| | | | | | Jobs within this Transaction. |
| Transaction | TranscodingParams | | | Optional | The transcoding parameters |
| | | | | | to be used for all the |
| | | | | | Transcoding Jobs within |
| | | | | | this Transaction. When a |
| | | | | | predefined Profile is |
| | | | | | specified and this tag |
| | | | | | appears, the values specified |
| | | | | | within this tag override the |
| | | | | | ones in the Profile. |
| Transaction | PolicyID | String | | Optional | The pre-defined policy to be |
| | | | | | used for the Transaction. |
| Transaction | PolicyParams | | | Optional | The policy rules to be used |
| | | | | | for this Transaction. When a |
| | | | | | predefined Policy is |
| | | | | | specified and this tag |
| | | | | | appears, the values specified |
| | | | | | within this tag override the |
| | | | | | ones in the Policy. |
| Transaction | TranscodingJob | | | Mandatory | Each individual transcoding |
| | | | | (1 or more) | request. |
| TranscodingJob | Source | | | Mandatory | The source for the |
| | | | | | Transcoding Job. |
| TranscodingJob | Target | | | Mandatory | The Target of this |
| | | | | | Transcoding Job. |
| Source | Type | String | “Combined”, | Optional | The type of the Source. |
| | | | “Audio”, | | |
| | | | “Image”, | | |
| | | | “Video”, | | |
| | | | “Text”, | | |
| | | | “SyntheticAudio” | | |
| Source | Format | String | According to the | Optional | The format of the Source. |
| | | | supported formats | | |
| Source | Codec | String | According to the | Optional | The codec of the Source. |
| | | | supported codecs | | |
| Source | Location | String | URL | Mandatory | The full-path on a shared |
| | | | | | storage or the Content ID of |
| | | | | | the attachment |
| Source | URLSettingsID | String | | Optional | If any specific settings |
| | | | | | (headers, passwords, etc.) |
| | | | | | should be used, in order to |
| | | | | | access the Source URL, then |
| | | | | | the Application Platform |
| | | | | | SHALL specify a reference |
| | | | | | to such a set of predefined |
| | | | | | settings through this |
| | | | | | parameter. |
| | | | | | The definition of the set of |
| | | | | | available settings is out of |
| | | | | | the scope of this specification |
| Target | ProfileID | String | | Optional | A predefined Profile to use |
| | | | | | for the Transcoding Job. |
| | | | | | When a ProfileID is defined |
| | | | | | at the Transaction level and |
| | | | | | this tag is present at the |
| | | | | | Transcoding Job level, the |
| | | | | | ProfileID at the Transcoding |
| | | | | | Job level overrides the one |
| | | | | | at the Transaction level. |
| Target | TranscodingParams | | | Optional | The transcoding parameters |
| | | | | | to be used for all the |
| | | | | | Transcoding Jobs within |
| | | | | | this Transaction. When a |
| | | | | | predefined Profile is |
| | | | | | specified and this tag |
| | | | | | appears, the values specified |
| | | | | | within this tag override the |
| | | | | | ones in the Profile. When |
| | | | | | TranscodingParams are |
| | | | | | defined at the Transaction |
| | | | | | level and this tag is present |
| | | | | | at the Transcoding Job level, |
| | | | | | the TranscodingParams at |
| | | | | | the Transcoding Job level |
| | | | | | override the ones at the |
| | | | | | Transaction level. |
| Target | Location | String | URL | Mandatory | The full-path on a shared |
| | | | | | storage or the Content ID of |
| | | | | | the attachment. |
| Target | URLSettingsID | String | | Optional | If any specific settings |
| | | | | | (headers, passwords, etc.) |
| | | | | | should be used, in order to |
| | | | | | access the Target URL, then |
| | | | | | the Application Platform |
| | | | | | SHALL specify a reference |
| | | | | | to such a set of predefined |
| | | | | | settings through this |
| | | | | | parameter. |
| | | | | | The definition of the set of |
| | | | | | available settings is out of |
| | | | | | the scope of this |
| | | | | | specification. |
| PolicyParams | DeleteOrder | | | Optional | Ordered list of media types |
| | | | | | to be deleted if necessary. |
| PolicyParams | CompressOrder | | | Optional | Ordered list of media types to |
| | | | | | compressed if necessary |
| DeleteOrder | MediaType | String | “Audio”, | Optional (1 | Media types in order of |
| | | | “Image”, | or more) | deletion. |
| | | | “Video”, | | |
| | | | “Text”, | | |
| | | | “SyntheticAudio”, | | |
| | | | “Combined” | | |
| CompressOrder | MediaType | String | “Audio”, | Optional (1 | Media types in order for |
| | | | “Image”, | or more) | compression. |
| | | | “Video”, | | |
| | | | “Text”, | | |
| | | | “SyntheticAudio”, | | |
| | | | “Combined” | | |
| TranscodingParams | SizeLimit | Integer | | Optional | The limit of the file sizes for |
| | | | | | the Transaction or the |
| | | | | | TranscodingJob. Default is |
| | | | | | unlimited (−1) |
| TranscodingParams | Audio | | | Optional | The audio transcoding |
| | | | | | parameters. |
| TranscodingParams | Image | | | Optional | The image transcoding |
| | | | | | parameters (also graphics). |
| TranscodingParams | Video | | | optional | The video transcoding |
| | | | | | parameters. |
| TranscodingParams | Text | | | Optional | The text transcoding |
| | | | | | parameters. |
| TranscodingParams | CombinedMedia | | | Optional | The combined-media |
| | | | | | transcoding parameters. |
| TranscodingParams | Transformation | | | Optional (0 | transformation that the |
| | | | | or more | content should go through |
| | | | | appearances) | |
| Transformation | Type | String | According to the | Optional | Type of transformation |
| | | | supported | | |
| | | | Transformations | | |
| Transformation | parameter | String | According to the | Optional | Value of parameter for this |
| | | | Supported | | Transformation |
| | | | parameter values | | |
| | | | for the specific | | |
| | | | transformation | | |
| Audio | Format | String | According to the | Optional | The file-format of the target. |
| | | | supported audio | | Any supported audio |
| | | | formats | | |
| Audio | Codec | String | According to the | Optional | The desired codec. |
| | | | supported audio | | Restricted by the file format |
| | | | codecs | | |
| Audio | BitRate | Integer | | Optional | The desired bit-rate. |
| | | | | | Restricted by the codec |
| Audio | SamplingRate | Integer | | Optional | The desired sampling rate. |
| | | | | | Restricted by the codec |
| Audio | SamplingResolution | Integer | Optional | | The desired sampling |
| | | | | | resolution. Restricted by the |
| | | | | | codec |
| Audio | Synthetic | | | Optional | Synthetic audio related |
| | | | | | parameters. |
| Synthetic | ChannelToUse | Integer | | Optional | Number of input channel to |
| | | | | | be used in case the output |
| | | | | | contains only one channel. |
| Synthetic | ChannelsPriority | String | | Optional | A comma separated |
| | | | | | permutation of 0-15. The |
| | | | | | priority of the channels, from |
| | | | | | the most important to the |
| | | | | | least important. |
| | | | | | Default is 0-15. |
| Synthetic | Instrument | Integer | | Optional | The instrument to use, when |
| | | | | | transcoding to midi. |
| | | | | | Irrelevant for other formats, |
| | | | | | default is piano |
| Audio | SizeLimit | Integer | | Optional | The limit of the file size for |
| | | | | | an audio. Default is |
| | | | | | unimited (−1) |
| Image | Format | String | According to the | Optional | The format of the target. |
| | | | supported image | | Any supported image |
| | | | formats | | |
| Image | ColorScheme | String | “True24Bit”, | Optional | The desired color scheme |
| | | | “True12Bit”, | | |
| | | | “Palette256Co”, | | |
| | | | “Palette256Gr”, | | |
| | | | “Palette32Co”, | | |
| | | | “Palette32Gr”, | | |
| | | | “Palette16Co”, | | |
| | | | “Palette16Gr”, | | |
| | | | “Palette4Co”, | | |
| | | | “Palette4Gr”, | | |
| | | | “1Bit” | | |
| Image | Width | Integer | | Optional | The target width. |
| | | | | | The default is the original |
| | | | | | width. |
| Image | Height | Integer | | Optional | The target height. |
| | | | | | The default is the original heig |
| Image | Resize | String | “AspectRatio”, | Optional | Maintain the aspect ratio |
| | Policy | | “Crop”, “None” | | when resizing (the new |
| | | | | | dimensions are set to fit into |
| | | | | | the desired width while |
| | | | | | aspect ratio is maintained), |
| | | | | | crop when shrinking (do not |
| | | | | | scale the image - take its |
| | | | | | central rectangle), or just |
| | | | | | stretch. |
| Image | SizeLimit | Integer | | Optional | Size limit for the image. |
| | | | | | Default is unlimited (−1) |
| Video | Format | String | According to the | Optional | The format of the target. |
| | | | supported video | | Any supported video |
| | | | formats | | |
| Video | Codec | String | According to the | Optional | The video codec of the |
| | | | supported video | | target. |
| | | | codecs | | |
| Video | Width | Integer | | Optional | Target width |
| Video | Height | Integer | | Optional | Target height |
| Video | FrameRate | Integer | | Optional | The wanted target frame rate |
| Video | BitRate | Integer | | Optional | The desired target bit rate |
| Video | Audio | | | Optional | Audio parameters. |
| Video | SizeLimit | Integer | | Optional | Size limit for the Audio. |
| | | | | | Default is unlimited (−1) |
| CombinedMedia | SizeLimit | Integer | | Optional | Size limit for the whole |
| | | | | | combined media. |
| | | | | | Default is unlimited (−1) |
| CombinedMedia | PresentationParams | | | Optional | Parameters for the target |
| | | | | | presentation. |
| PresentationParams | Format | String | “SMIL”, | Optional | Target presentation format |
| | | | “HTML”, “None” | | |
| PresentationParams | Template | String | | Optional | Template for presentation to |
| | | | | | be used in case of |
| | | | | | presentation format change. |
| | | | | | This is either a URL, or a |
| | | | | | content ID of the attachment |
| PresentationParams | Layout | String | “Portrait”, | Optional | Target layout. |
| | | | “Landscape” | | Default is the source layout. |
| CombinedMedia | Encoding | String | “Textual”, | Optional | The encoding of the output |
| | | | “WAP” | | MIME-Multipart. |
| | | | | | Default is textual. |
| CombinedMedia | TranscodingParams | | | Optional | Transcoding Parameters for |
| | | | | | media-elements inside the |
| | | | | | combined-media (more than |
| | | | | | one media type may be |
| | | | | | specifled here). The |
| | | | | | Parameters are specified for |
| | | | | | all the content-elements of |
| | | | | | the same type. |
| | | | | | For example, in order to |
| | | | | | transcode a video to a |
| | | | | | combined-media (e.g. |
| | | | | | image/s + audio + presentation), |
| | | | | | the target Parameters for |
| | | | | | the audio, image, and |
| | | | | | presentation are specified |
| | | | | | here. |
| CombinedMedia | OverallParams | | | Optional | Limitations on media |
| | | | | | parameters in the combined- |
| | | | | | media. |
| OverallParams | Width | Integer | | Optional | Target width |
| OverallParams | Height | Integer | | Optional | Target height |
| OverallParams | BitsPerPixel | Integer | | Optional | Supported Number of bits |
| | | | | | per pixel |
| OverallParams | AllowColor | Boolean | | Optional | Indication whether color |
| | | | | | images are allowed as an |
| | | | | | output. |
| OverallParams | MaxImageWidth | Integer | | Optional | Maximum width |
| | | | | | allowed for |
| | | | | | image. |
| OverallParams | MaxImageHeight | Integer | | Optional | Maximum height |
| | | | | | allowed for |
| | | | | | an image. |
| OverallParams | AllowImage | Boolean | | Optional | Indication whether |
| | | | | | output |
| | | | | | can contain image. |
| OverallParams | AllowAudio | Boolean | | Optional | Indication whether |
| | | | | | output |
| | | | | | can contain audio. |
| OverallParams | AllowVideo | Boolean | | Optional | Indication whether |
| | | | | | output can contain video |
| OverallParams | SupportedContentTypes | | | Optional | A list of the supported |
| | | | | | content types. |
| SupportedContentTypes | Type | String | | Optional | A single content type |
| | | | | 1 or more) | |

In order to perform transformations on the media, the Application Platform specifies, for each requested transformation, the type of the transformation and the parameter for the transformation. The following Table 2 lists the minimal set of supported transformations, the allowed parameter values for these transformations, and the type (or types) of media elements on which these transformations may be used. STI supports other proprietary Transformations that will then have to be defined between the Application Platform and the Transcoding Platform. If the Transcoding Platform does not recognize the Transformation type, it returns an error.

TABLE 2

| Transformation | | | |
|---|---|---|---|
| Type | Possible parameter values | Media Types | Description |
| LevelCorrection | No parameter | Image | Perform level correction. |
| Mirror | “UD”, “LR, | Image | “UD” - vertical mirror, “LR” - |
| | “Diagonal”, | | horizontal mirror. Default is |
| | “None” | | “None”. |
| NoiseReduction | No parameter | Image | Perform noise reduction. |
| Rotation | Angle of clockwise | Image | Perform Image rotation |
| | rotation (0-359) | | |
| Sharpen | No parameter | Image | Perform image sharpening. |
| DurationLimit | Limit on duration (in | Video, Audio, | Truncate the media if its duration |
| | milliseconds) | CombinedMedia (e.g. | exceeds this limit. |
| | | for slideshow) | |
| AGC | No parameter | Audio | Perform Automatic Gain Control |
| Offset | Offset in source media | Audio, Video | the source image to start the |
| | (in | | Transcoding from. |
| | milliseconds) | | |
| AudioChannels | “Mono”, “Stereo”, | Audio | Change the number of channels |
| | “DualMono”, | | in the output. |
| | “IntensityStereo” | | |
| FrameRateSample | New frame rate | Image (e.g. for | Change the frame sampling rate |
| | | slideshow) | (without changing the speed and |
| | | | the duration of the media) |
| FrameRateOutput | New frame rate | Image (e.g. for | Change the frame rate in the |
| | | slideshow) | output (and thus change also |
| | | | the speed and the duration of |
| | | | the media). |
| NumberOfFrames | New number of frames | Image (e.g. for | Change the number of frames in |
| | | slideshow) | the output. |

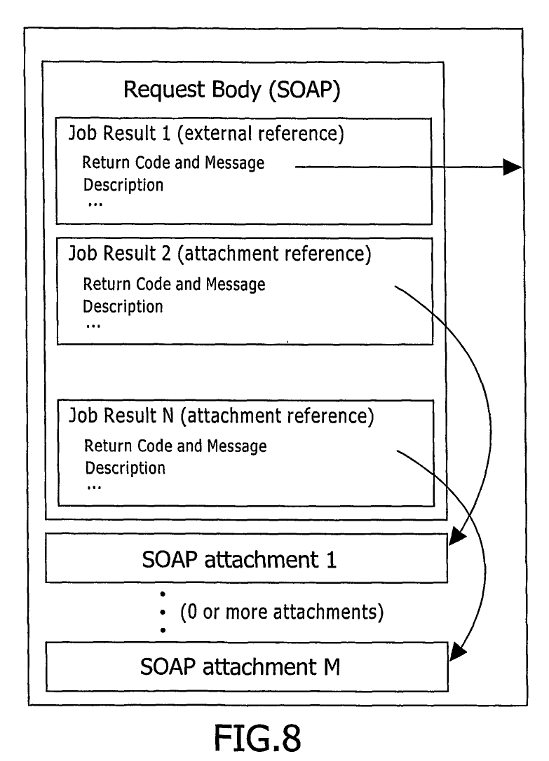

A request Transaction is considered as successful unless there was an error during the handling of the transaction that prevented the completion of the whole Transaction. Errors in specific Transcoding Jobs do not affect the success value of the entire Request Transaction. That is, a Request Transaction may be successful even though some (or all) of the Transcoding Jobs failed. The structure of a successful Response Transaction, containing the results of one or more Transcoding Jobs, is quite similar to the Request Transaction, i.e. a SOAP header, including a success code, and one or more Job Results and optionally the Content attachments. The Response Body contains references to either external content element or self-contained content elements. The same differences between a Transaction with contained content elements and without contained content elements, as discussed in the Request Transaction, apply for Response Transactions. FIG. 8 shows the structure of the Response Transaction. As for the Request Body, a table indicates (Table 3) how the Response Body is structured:

TABLE 3

| Parent | Name | Type | Possible values | Comments |
|---|---|---|---|---|
| | Transaction | | | The response |
| Transaction | ReturnCode | Integer | | The return code of the |
| | | | | Transaction (either a |
| | | | | successful or a warning) |
| Transaction | NumJobResults | Integer | | How many Job Results |
| | | | | residue in this response. |
| Transaction | ProfileID | String | | The Profile ID that was |
| | | | | used for this transaction |
| | | | | (in case it was specified |
| | | | | in the Transaction block |
| | | | | of the request) |
| Transaction | PolicyID | String | | The Policy ID that was |
| | | | | used for this transaction |
| | | | | (in case it was specified |
| | | | | in the Transaction block |
| | | | | of the request) |
| Transaction | TransactionID | Integer | | The unique ID that was |
| | | | | received from the |
| | | | | Application Platform in |
| | | | | the request |
| Transaction | ContextID | Integer | | A unique ID of the |
| | | | | transcoding session |
| | | | | that is given by the |
| | | | | Transcoding Platform. |
| Transaction | TotalDuration | Integer | | The time it took the |
| | | | | Transcoding Platform to |
| | | | | perform the entire |
| | | | | transcoding Transaction |
| | | | | in milliseconds. This |
| | | | | number is the duration |
| | | | | of the whole transaction |
| | | | | from the time it reached |
| | | | | the Transcoding |
| | | | | Platform to the time the |
| | | | | response was sent (it |
| | | | | can be higher or lower |
| | | | | the sum of durations for |
| | | | | all the Job Results). |
| Transaction | JobResult | | | The Job Results. May |
| | | | | be more than one (one |
| | | | | per each Transcoding Job) |
| JobResult | ReturnCode | Integer | | The return code of the |
| | | | | Transcoding Job (either |
| | | | | a successful or a |
| | | | | warning) |
| JobResult | Message | String | | A message with an |
| | | | | explanation in case of a |
| | | | | warning |
| JobResult | Duration | Integer | | The duration it took this |
| | | | | Transcoding Job (in |
| | | | | milliseconds) |
| JobResult | Target | | | Details about the target. |
| Target | FileSize | Integer | | The actual size of the file |
| Target | Location | String | | The full-path on a |
| | | | | shared storage or the |
| | | | | Content ID of the |
| | | | | attachment. |
| Target | ProfileID | String | | The Profile ID that was |
| | | | | used for this |
| | | | | Transcoding Job (in |
| | | | | case it was specified). |
| Target | TranscodingParams | | | The Transcoding |
| | | | | Parameters of the target. |
| TranscodingParams | SizeLimit | Integer | | The limit that was given |
| | | | | to the entire transaction |
| TranscodingParams | Audio | | | Audio details |
| TranscodingParams | Image | | | Image details |
| TranscodingParams | Video | | | Video details |
| TranscodingParams | Text | | | Text details |
| TranscodingParams | CombinedMedia | | | Combined-media details |
| TranscodingParams | Transformation | | | A Transformation that |
| | | | | was applied (0 or more |
| | | | | appearances). |
| Transformation | Type | String | According to the | Type of transformation |
| | | | supported | |
| | | | Transformations | |
| Transformation | Parameter | String | According to the | Value of parameter for |
| | | | Supported | this transformation |
| | | | parameter values | |
| | | | for the specific | |
| | | | transformation | |
| Audio | Format | String | The supported | The file format |
| | | | audio formats | |
| Audio | Codec | String | The supported | The codec |
| | | | audio codecs | |
| Audio | BitRate | Integer | | The bit-rate |
| Audio | SamplingRate | Integer | | The sampling rate |
| Audio | SamplingResolution | Integer | | The sampling resolution |
| Audio | SizeLimit | Integer | | The limit that was given |
| | | | | for an audio |
| Audio | Synthetic | | Optional | Synthetic audio related |
| | | | | parameters. |
| Synthetic | ChannelToUse | Integer | Optional | Number of input channel |
| | | | | used in case the output |
| | | | | contains only one channel. |
| Synthetic | ChannelsPriority | String | Optional | A comma separated |
| | | | | permutation of 0-15. The |
| | | | | priority of the channels, |
| | | | | from the most important |
| | | | | to the least important. |
| Synthetic | Instrument | Integer | Optional | The instrument used, |
| | | | | when transcoding to |
| | | | | midi. Irrelevant for other |
| | | | | formats. |
| Image | Format | String | The supported | The format |
| | | | image formats | |
| Image | ColorScheme | String | “True24Bit”, | The color scheme of the |
| | | | “True12Bit”, | image |
| | | | “Palette256Co”, | |
| | | | “Palette256Gr”, | |
| | | | “Palette32Co”, | |
| | | | “Palette32Gr”, | |
| | | | “Palette16Co”, | |
| | | | “Pallete16Gr”, | |
| | | | “Palette4Co”, | |
| | | | “Palette4Gr”, | |
| | | | “1Bit” | |
| Image | NunberOfColors | Integer | | The actual number of |
| | | | | colors |
| Image | Width | Integer | | The width |
| Image | Height | Integer | | The height |
| Image | SizeLimit | Integer | | The limit that was given |
| | | | | for an image |
| Video | Format | String | The supported | The format |
| | | | video formats | |
| Video | Codec | String | The supported | The codec |
| | | | video codecs | |
| Video | Width | Integer | | The width |
| Video | Height | Integer | | The height |
| Video | FrameRate | Integer | | The frame rate |
| Video | BitRate | Integer | | The bit rate |
| Video | SizeLimit | Integer | | The limit that was given |
| | | | | for a video |
| CombinedMedia | SizeLimit | Integer | | The limit that was given |
| | | | | for a combined-media |
| CombinedMedia | PresentationParams | | | Parameters for the target |
| | | | | presentation |
| | | | | transcoding. |
| PresentationParams | Format | String | “SMIL”, | Target presentation |
| | | | “HTML”, | format |
| | | | “None” | |
| PresentationParams | Template | String | | Template for |
| | | | | presentation that was |
| | | | | used. |
| PresentationParams | Layout | String | “Portrait”, | Target layout. |
| | | | “Landscape” | |
| CombinedMedia | Encoding | String | “Textual”, | The encoding of the |
| | | | “WAP” | output MIME-Multipart. |

A Transaction Failure response is returned in a situation where the whole Transaction could not be handled. This may happen if there was a problem with the Transaction parameters, or any other problem, which relates to the whole Transaction (and not only to one or more of the Transcoding Jobs). The header of a Transcoding error contains a line that indicates that there was an error (HTTP/1.1 500 Error), and the regular fields. The body of the SOAP, of a different structure from a successful one, is given in Table 4 below:

TABLE 4

| Parent | Name | Type | Possible values | Description |
|---|---|---|---|---|
| | FaultResponse | | | The fault |
| FaultResponse | TransactionID | Integer | | The unique ID that was |
| | | | | received from |
| | | | | the Application Platform in the |
| | | | | request |
| FaultResponse | ContextID | Integer | | A unique ID of the |
| | | | | transcoding session |
| | | | | that is given by the |
| | | | | Transcoding platform |
| FaultResponse | TotalDuration | Integer | | The total milliseconds it took |
| | | | | the whole |
| | | | | Transaction to be handled |
| | | | | (until the error occurred) |
| FaultResponse | ReturnCode | Integer | Out of the possible | |
| | | | error codes | |
| FaultResponse | Message | String | | An explanatory error message |

It may be added that the Transcoding Platform supports the Transaction error codes indicated in the following Table 5:

TABLE 5

| Error code | Error string |
|---|---|
| 1001 | Parsing error |
| 1004 | Erroneous target structure |
| 1005 | Error in target data |
| 1006 | General server error |
| 1008 | No media detected in request message |
| 1009 | Response composition error (<err-code>) |
| 1010 | Number of concurrent requests exceeded the maximum |
| 1011 | Erroneous transcoding request |
| 1012 | Transaction result exceed maximal size |
| 1013 | Policy could not be accomplished and transaction failed. |
| 1014 | Policy could not be accomplished but transaction succeeded. |

and that Transcoding Platform supports the Transcoding Job error codes indicated in the following Table 6:

TABLE 6

| Error code | Error string |
|---|---|
| 2001 | Error in input media |
| 2002 | Unsupported Content Type |
| 2003 | Unsupported Content Format |
| 2004 | Unsupported Content Codec |
| 2005 | Unsupported Content |
| 2006 | Unsupported transcoding request |
| 2006 | Unsupported Transformation |
| 2007 | No media detected in request message |
| 2008 | Output content size exceeds the limit |
| 2009 | Failed to read source content. |
| 2010 | Failed to write target content. |
| 2101 | DRM protected content: no transcoding done |

1. A transcoding system comprising an application platform and a transcoding platform for executing transcoding transactions that comprise the following steps:
transmission of a request from said application platform to said transcoding platform,
execution of said request by said transcoding platform,
transmission of a response from said transcoding platform to said application platform,
wherein said request is based on a request body which is structured as indicated in Table 1, and said response, when successful, is based on a response body which is structured as indicated in Table 3.

2. A transcoding system as claimed in claim 1, wherein said request has a transcoding parameter element comprising a transformation element that defines a transformation through which a content must go, amongst a plurality of supported transformations as defined in Table 2.

3. A device hosting an application platform for use in a transcoding system as claimed in claim 1.

4. A device hosting a transcoding platform for use in a transcoding system as claimed in claim 1.

5. A request having the format described in Table 1 of a transcoding system as defined in claim 1.

6. A request having a transcoding parameter element comprising a transformation element that defines a transformation through which a content must go, amongst a plurality of supported transformations as defined in Table 3 of a transcoding system as defined in claim 2.

7. A response having the format described in Table 2 of a transcoding system as defined in claim 1.
